(19) United States
(12) Patent Application Publication
(10) Pub. No.: US 2024/0336515 A1
(43) Pub. Date: Oct. 10, 2024

(54) GLASS

(71) Applicant: AGC Inc., Tokyo (JP)

(72) Inventors: Naoki KANNO, Tokyo (JP); Shigeki SAWAMURA, Tokyo (JP)

(73) Assignee: AGC Inc., Tokyo (JP)

(21) Appl. No.: 18/746,553

(22) Filed: Jun. 18, 2024

Related U.S. Application Data
(63) Continuation of application No. PCT/JP2022/046463, filed on Dec. 16, 2022.

(30) Foreign Application Priority Data
Dec. 20, 2021 (JP) 2021-206529

(51) Int. Cl. C03C 3/21

(52) U.S. Cl. CPC C03C 3/21

(57) ABSTRACT

Provided is glass having a high refractive index and capable of suppressing the risk of breakage. In glass (10), in mole percentage on an oxide basis, a content of TeO₂ is more than 10.1% and less than 40.0%, a parameter A defined by Formula (1) is 65 or more, and a total content of P₂O₅, TeO₂, B₂O₃, TiO₂, Ta₂O₅, WO₃, ZrO₂, Bi₂O₃, and ZnO is 90% or more.

### CROSS-REFERENCE TO RELATED APPLICATIONS

This application is a Bypass Continuation of International Application No. PCT/JP2022/046463, filed on Dec. 16, 2022, which claims priority to Japanese Patent Application No. 2021-206529, filed on Dec. 20, 2021. The entire contents of which are incorporated herein by reference.

### FIELD

The present invention relates to glass.

### BACKGROUND

In recent years, there is a demand for glass having a high refractive index. Particularly, for example, in wearable devices such as a head-mounted display that implements Augmented Reality (AR), Virtual Reality (VR), Mixed Reality (MR), and the like, a light guide plate is required to have a high refractive index property with respect to visible light. For example, Patent Literature 1 describes an optical glass having a high refractive index and a high transmittance.

### CITATION LIST

### Patent Literature

Patent Literature 1: JP 2010-195674 A

### SUMMARY

### Technical Problem

However, since the glass having a high refractive index is generally brittle and easily broken, it is required to suppress the risk of breakage.

The present invention has been made in view of the above problems, and an object thereof is to provide glass having a high refractive index and capable of suppressing the risk of breakage.

### Solution to Problem

To solve the problem above, a glass of the present disclosure comprises, in mole percentage on an oxide basis, a content of TeO₂ is more than 10.1% and less than 40.0%, a parameter A defined by Formula (A) is 65 or more, and a total content of P₂O₅, TeO₂, B₂O₃, TiO₂, Ta₂O₅, WO₃, ZrO₂, Bi₂O₃, and ZnO is 90% or more.

$$A = 3.11462 0 \cdot c ( {P}_{2} {O}_{5} ) + 0.30878 \cdot c ( {TeO}_{2} ) + 1.018169 \cdot c ( {B}_{2} {O}_{3} ) + 1.144722 \cdot c ( {TiO}_{2} ) + 1.296491 \cdot c ( {Ta}_{2} {O}_{5} ) + 0.815743 \cdot c ( {WO}_{3} ) + 1.172518 \cdot c ( {ZrO}_{2} ) + 0.266476 \cdot c ( {Bi}_{2} {O}_{3} ) + 0.339981 \cdot c ( ZnO ) \qquad ( A )$$

c(P₂O₅) is a content (%) of P₂O₅ in mole percentage on an oxide basis,
c(TeO₂) is a content (%) of TeO₂ in mole percentage on an oxide basis,
c(B₂O₃) is a content (%) of B₂O₃ in mole percentage on an oxide basis,
c(TiO₂) is a content (%) of TiO₂ in mole percentage on an oxide basis,
c(Ta₂O₅) is a content (%) of Ta₂O₅ in mole percentage on an oxide basis,
c(WO₃) is a content (%) of WO₃ in mole percentage on an oxide basis,
c(ZrO₂) is a content (%) of ZrO₂ in mole percentage on an oxide basis,
c(Bi₂O₃) is a content (%) of Bi₂O₃ in mole percentage on an oxide basis, and
c(ZnO) is a content (%) of ZnO in mole percentage on an oxide basis.

According to the present disclosure, it is possible to provide glass having a high refractive index and capable of suppressing the risk of breakage.

### BRIEF DESCRIPTION OF DRAWINGS

FIG. 1 is a schematic view of glass according to the present embodiment.

FIG. 2 is a cross-sectional view assuming that the glass according to the present embodiment is a glass plate.

### DESCRIPTION OF EMBODIMENTS

The following describes a preferred embodiment of the present invention in detail with reference to the attached drawings. The present invention is not limited to the embodiment, and in a case in which there are a plurality of embodiments, the embodiments may be combined with each other. Numerical values encompass rounded numerical values.

### (Glass)

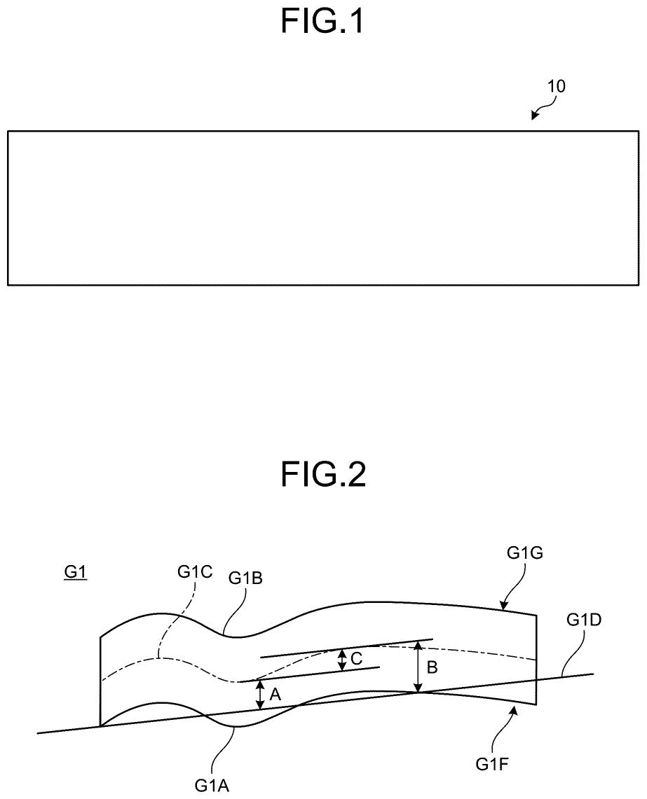

FIG. 1 is a schematic view of glass according to the present embodiment. As illustrated in FIG. 1, glass 10 according to the present embodiment is a glass plate having a plate shape, but the shape of the glass 10 is not limited to the plate shape and may be optional. In the present embodiment, the glass 10 is used as a light guide plate. More specifically, the glass 10 is used as a light guide plate for a head-mounted display. The head-mounted display is a display device (wearable device) mounted on a person's head. However, a use of the glass 10 is optional, and the glass 10 is not necessarily used as a light guide plate, and is not necessarily used for a head-mounted display.

### (Parameter A)

A parameter A of the glass 10 will be described. The parameter A is a parameter related to a Young's modulus calculated from the composition of the glass 10. For example, as the value of the parameter A increases, the Young's modulus tends to increase. The parameter A is calculated as in the following Formula (A).

$$A = 3.11462 0 \cdot c ( {P}_{2} {O}_{5} ) + 0.30878 \cdot c ( {TeO}_{2} ) + 1.018169 \cdot c ( {B}_{2} {O}_{3} ) + 1.144722 \cdot c ( {TiO}_{2} ) + 1.296491 \cdot c ( {Ta}_{2} {O}_{5} ) + 0.815743 \cdot c ( {WO}_{3} ) + 1.172518 \cdot c ( {ZrO}_{2} ) + 0.266476 \cdot c ( {Bi}_{2} {O}_{3} ) + 0.339981 \cdot c ( ZnO ) \qquad ( A )$$

Here, c in Formula (A) is a content (%) of oxide shown in parentheses with respect to the entire glass 10 in mole percentage on an oxide basis. That is,
c(P₂O₅) is a content (%) of P₂O₅ with respect to the entire glass 10 in mole percentage on an oxide basis,
c(TeO₂) is a content (%) of TeO₂ with respect to the entire glass 10 in mole percentage on an oxide basis,
c(B₂O₃) is a content (%) of B₂O₃ with respect to the entire glass 10 in mole percentage on an oxide basis,
c(TiO₂) is a content (%) of TiO₂ with respect to the entire glass 10 in mole percentage on an oxide basis,
c(Ta₂O₅) is a content (%) of Ta₂O₅ with respect to the entire glass 10 in mole percentage on an oxide basis,
c(WO₃) is a content (%) of WO₃ with respect to the entire glass 10 in mole percentage on an oxide basis,
c(ZrO₂) is a content (%) of ZrO₂ with respect to the entire glass 10 in mole percentage on an oxide basis,
c(Bi₂O₃) is a content (%) of Bi₂O₃ with respect to the entire glass 10 in mole percentage on an oxide basis, and
c(ZnO) is a content (%) of ZnO with respect to the entire glass 10 in mole percentage on an oxide basis.

The parameter A of the glass 10 is 65 or more, preferably 66 or more and 110 or less, and more preferably 67 or more and 108 or less. When the parameter A is in this range, the Young's modulus can be kept high, and the risk of breakage can be suppressed.

The glass 10 may contain oxides other than those listed in Formula (A), but the contents of the oxides other than those listed in Formula (A) are not used for the calculation of the parameter A. That is, it can be said that the value of the parameter A does not change depending on the presence or absence of oxides other than those listed in Formula (A).

The glass 10 is not limited to those containing all the oxides listed in Formula (A). In this case, the value on the right side of Formula (A) for the oxide listed in Formula (A) but not contained in the glass 10 is zero (0). That is, for example, when WO₃ is not contained in the glass 10, the parameter A is calculated with c (WO₃) in Formula (A) as zero (0).

### (Glass Composition)

The following describes the composition of the glass 10.

### (TeO₂)

TeO₂ is a component contributing to an increase in refractive index while promoting vitrification. On the other hand, when this component is contained in a large amount, the mechanical characteristics of the glass are deteriorated. That is, in the glass 10, in mole percentage on an oxide basis, a content of TeO₂ is more than 10.1% and less than 40.0%, preferably 13.0% or more and 38.0% or less, and further preferably 15.0% or more and 36.5% or less. When the content of TeO₂ is in this range, the glass 10 can have a high refractive index while maintaining a high Young's modulus.

Herein, the content indicates a mole percentage of a content of oxide assuming that a mole percentage of a total amount of the glass 10 is 100% in mole percentage on an oxide basis. That is, for example, “the content of TeO₂ is more than 10.1%” means that TeO₂ is contained in an amount of more than 10.1% assuming that the mole percentage of the total amount of the glass 10 is 100% in mole percentage on an oxide basis.

(P₂O₅)

P₂O₅ is a glass-forming component and stabilizes the glass. On the other hand, when this component is contained in an excessively large amount, the refractive index decreases. Therefore, in the glass 10, in mole percentage on an oxide basis, a content of P₂O₅ is preferably 0% or more, more preferably 0.1% or more, and further preferably 1.0% or more. In the glass 10, in mole percentage on an oxide basis, the content of P₂O₅ is preferably 30.0% or less, more preferably 24.0% or less, and further preferably 18.0% or less.

That is, it can be said that in the glass 10, in mole percentage on an oxide basis, the content of P₂O₅ is preferably 0% or more and 30% or less, preferably 0% or more and 30.0% or less, more preferably 0.1% or more and 24.0% or less, further preferably 1.0% or more and 18.0% or less, and further preferably 5.6% or more and 15.1% or less. When the content of P₂O₅ is in this range, the glass 10 can have a high refractive index while maintaining a high Young's modulus. However, the glass 10 may not contain P₂O₅.

(B₂O₃)

B₂O₃ is a glass-forming component and is a component contributing to improvement of the stability of the glass and improving the production characteristics, but when this component is contained in a large amount, the refractive index tends to decrease. Therefore, in the glass 10, in mole percentage on an oxide basis, a content of B₂O₃ is preferably 1.0% or more, more preferably 5.0% or more, and further preferably 10.0% or more. When a lower limit value of B₂O₃ is in this range, stability of the glass can be maintained, which is preferable. In the glass 10, in mole percentage on an oxide basis, the content of B₂O₃ is preferably 40.0% or less, more preferably 35.0% or less, and further preferably 33.0% or less. When an upper limit value of B₂O₃ is in this range, a high refractive index is achieved, which is preferable.

That is, it can be said that in the glass 10, in mole percentage on an oxide basis, the content of B₂O₃ is preferably 0% or more and 40% or less, preferably 1.0% or more and 40.0% or less, more preferably 5.0% or more and 35.0% or less, further preferably 10.0% or more and 33.0% or less, and further preferably 16.5% or more and 31.1% or less. When the content of B₂O₃ is in this range, the glass 10 can have a high refractive index while maintaining a high Young's modulus. However, the glass 10 may not contain B₂O₃.

### (Li₂O)

Li₂O is a component capable of improving the mechanical properties of the glass. On the other hand, when this component is contained in an excessively large amount, the glass is easy to devitrify, and the production characteristics are deteriorated. Therefore, in the glass 10, in mole percentage on an oxide basis, a content of Li₂O is preferably 0% or more, more preferably 0.10% or more, and further preferably 1.00% or more. In the glass 10, in mole percentage on an oxide basis, the content of Li₂O is preferably 15.0% or less, more preferably 10.0% or less, and further preferably 5.0% or less.

That is, it can be said that in the glass 10, in mole percentage on an oxide basis, the content of Li₂O is preferably 0% or more and 15.0% or less, more preferably 0.10% or more and 10.0% or less, further preferably 1.00% or more and 5.0% or less, and further preferably 0% or more and 3.0% or less. When the content of Li₂O is in this range, the glass 10 can have a high refractive index while maintaining a high Young's modulus. However, the glass 10 may not contain Li₂O.

### (Na₂O)

In the glass 10, in mole percentage on an oxide basis, a content of Na₂O is preferably 0% or more, more preferably 0.10% or more, and further preferably 0.50% or more. In the glass 10, in mole percentage on an oxide basis, the content of Na₂O is preferably 15.0% or less, more preferably 5.0% or less, and further preferably 1.0% or less.

That is, it can be said that in glass 10, in mole percentage on an oxide basis, the content of Na₂O is preferably 0% or more and 15.0% or less, more preferably 0.10% or more and 5.0% or less, and further preferably 0.50% or more and 1.0% or less. When the content of Na₂O is in this range, the glass 10 can have a high refractive index while maintaining a high Young's modulus. However, the glass 10 may not contain Na₂O.

### (K₂O)

In the glass 10, in mole percentage on an oxide basis, a content of K₂O is preferably 0% or more, more preferably 0.10% or more, and further preferably 0.50% or more. In the glass 10, in mole percentage on an oxide basis, the content of K₂O is preferably 15.0% or less, more preferably 5.0% or less, and further preferably 1.0% or less.

That is, it can be said that in the glass 10, in mole percentage on an oxide basis, the content of K₂O is preferably 0% or more and 15.0% or less, more preferably 0.10% or more and 5.0% or less, and further preferably 0.50% or more and 1.0% or less. When the content of K₂O is in this range, the glass 10 can have a high refractive index while maintaining a high Young's modulus. However, the glass 10 may not contain K₂O.

### (TiO₂)

TiO₂ is a high refractive index component, but when this component is contained in a large amount, the internal transmittance of the glass is lowered. Therefore, in the glass 10, in mole percentage on an oxide basis, a content of TiO₂ is preferably 0% or more, more preferably 0.20% or more, and further preferably 0.40% or more. In the glass 10, in mole percentage on an oxide basis, the content of TiO₂ is preferably 20.0% or less, more preferably 15.0% or less, and further preferably 10.0% or less.

That is, it can be said that in glass 10, in mole percentage on an oxide basis, the content of TiO₂ is preferably 0% or more and 20.0% or less, more preferably 0.20% or more and 15.0% or less, and further preferably 0.40% or more and 10.0% or less. When the content of TiO₂ is in this range, the glass 10 can have a high refractive index while maintaining a high Young's modulus. However, the glass 10 may not contain TiO₂.

(Ta₂O₅)

Ta₂O₅ is a component capable of increasing a refractive index, but when this component is contained in an excessively large amount, the glass is easy to devitrify, and the production characteristics are deteriorated. Therefore, in the glass 10, in mole percentage on an oxide basis, a content of Ta₂O₅ is preferably 0% or more, more preferably 0.20% or more, and further preferably 0.40% or more. In the glass 10, in mole percentage on an oxide basis, the content of Ta₂O₅ is preferably 20.0% or less, more preferably 10.0% or less, and further preferably 5.0% or less.

That is, it can be said that in the glass 10, in mole percentage on an oxide basis, the content of Ta₂O₅ is preferably 0% or more and 20.0% or less, more preferably 0.20% or more and 10.0% or less, further preferably 0.40% or more and 5.0% or less, and further preferably 0% or more and 3.0% or less. When the content of Ta₂O₅ is in this range, the glass 10 can have a high refractive index while maintaining a high Young's modulus. However, the glass 10 may not contain Ta₂O₅.

### (WO₃)

WO₃ is a component capable of increasing the refractive index of the glass, but when this component is contained in an excessively large amount, the internal transmittance decreases. Therefore, in the glass 10, in mole percentage on an oxide basis, a content of WO₃ is preferably 0% or more, more preferably 0.10% or more, and further preferably 0.20% or more. In the glass 10, in mole percentage on an oxide basis, the content of WO₃ is preferably 15.0% or less, more preferably 10.0% or less, and further preferably 6.0% or less.

That is, it can be said that in the glass 10, in mole percentage on an oxide basis, the content of WO₃ is preferably 0% or more and 15.0% or less, more preferably 0.10% or more and 10.0% or less, further preferably 0.20% or more and 6.0% or less, and further preferably 0% or more and 1.0% or less. When the content of WO₃ is in this range, the glass 10 can have a high refractive index while maintaining a high Young's modulus. However, the glass 10 may not contain WO₃.

(Nb₂O₅)

Nb₂O₅ is a component increasing the refractive index of the glass and is a component improving mechanical characteristics, but when this component is contained in a large amount, the glass is easy to devitrify, and the production characteristics are deteriorated. Therefore, in the glass 10, in mole percentage on an oxide basis, a content of Nb₂O₅ is preferably 0% or more, more preferably 0.10% or more, and further preferably 0.20% or more. In the glass 10, in mole percentage on an oxide basis, the content of Nb₂O₅ is preferably 15.0% or less, more preferably 12.0% or less, and further preferably 10.0% or less.

That is, it can be said that in the glass 10, in mole percentage on an oxide basis, the content of Nb₂O₅ is preferably 0% or more and 15.0% or less, preferably 0% or more and less than 15.0%, more preferably 0.10% or more and 12.0% or less, further preferably 0.20% or more and 10.0% or less, and further preferably 1.6% or more and 9.0% or less. When the content of Nb₂O₅ is in this range, the glass 10 can have a high refractive index while maintaining a high Young's modulus. However, the glass 10 may not contain Nb₂O₅.

### (ZrO₂)

ZrO₂ is a component capable of improving mechanical properties while improving a refractive index, but when this component is contained in an excessively large amount, the glass is easy to devitrify, and the production characteristics are deteriorated. Therefore, in the glass 10, in mole percentage on an oxide basis, a content of ZrO₂ is preferably 0% or more, more preferably 0.1% or more, and further preferably 0.2% or more. In the glass 10, in mole percentage on an oxide basis, the content of ZrO₂ is preferably 15% or less, more preferably 10% or less, and further preferably 6% or less.

That is, it can be said that in the glass 10, in mole percentage on an oxide basis, the content of ZrO₂ is preferably 0% or more and 15% or less, more preferably 0.1% or more and 10% or less, and further preferably 0.2% or more and 6% or less. When the content of ZrO₂ is in this range, the glass 10 can have a high refractive index while maintaining a high Young's modulus. However, the glass 10 may not contain ZrO₂.

(Bi₂O₃)

Bi₂O₃ can greatly improve a refractive index, but when this component is contained in a large amount, not only the production characteristics are deteriorated but also the transmittance is lowered. Therefore, in the glass 10, in mole percentage on an oxide basis, a content of Bi₂O₃ is preferably 15% or more, more preferably 18% or more, and further preferably 20% or more. When a lower limit value of Bi₂O₃ is in this range, a high refractive index is achieved, which is preferable. In the glass 10, in mole percentage on an oxide basis, the content of Bi₂O₃ is preferably 45% or less, more preferably 42% or less, and further preferably 39% or less. When an upper limit value of Bi₂O₃ is in this range, a high transmittance is achieved, which is preferable.

That is, it can be said that in the glass 10, in mole percentage on an oxide basis, the content of Bi₂O₃ is preferably more than 15% and 45% or less, more preferably 18% or more and 42% or less, further preferably 20% or more and 39% or less, and further preferably 21.3% or more and 38.1% or less. When the content of Bi₂O₃ is in this range, the glass 10 can have a high refractive index while maintaining a high Young's modulus. However, the glass 10 may not contain Bi₂O₃.

### (ZnO)

In the glass 10, in mole percentage on an oxide basis, a content of ZnO is preferably 0% or more, more preferably 0.2% or more, and further preferably 1.0% or more. In the glass 10, in mole percentage on an oxide basis, the content of ZnO is preferably 20% or less, more preferably 15% or less, and further preferably 12% or less.

That is, it can be said that in the glass 10, in mole percentage on an oxide basis, the content of ZnO is preferably 0% or more and 20% or less, more preferably 0.2% or more and 15% or less, further preferably 1.0% or more and 12% or less, and further preferably 3.4% or more and 9.5% or less. When the content of ZnO is in this range, the glass 10 can have a high refractive index while maintaining a high Young's modulus. However, the glass 10 may not contain ZnO.

(P₂O₅+TeO₂+B₂O₃+TiO₂+Ta₂O₅+WO₃+ZrO₂+Bi₂O+ZnO)

In the glass 10, in molar ratio on an oxide basis, (P₂O₅+TeO₂+B₂O₃+TiO₂+Ta₂O₅+WO₃+ZrO₂+Bi₂O+ZnO), that is, a total content of P₂O₅, TeO₂, B₂O₃, TiO₂, Ta₂O₅, WO₃, ZrO₂, Bi₂O₃, and ZnO is preferably 90% or more, more preferably 90% or more and 97.3% or less, and further preferably 91.5% or more and 97.3% or less. When the total content of these components is in this range, the glass 10 can have a high refractive index while maintaining a high Young's modulus. However, the glass 10 may not include at least one of these components.

(TeO₂/B₂O₃)

In the glass 10, in molar ratio on an oxide basis, {TeO₂/B₂O₃}, that is, a molar ratio of the content of TeO₂ to the content of B₂O₃ is preferably 0 or more and 10 or less, more preferably 0.10 or more and 5.0 or less, further preferably 0.20 or more and 3.0 or less, and further preferably 0.5 or more and 2.2 or less. When the content of TeO₂ with respect to B₂O₃ is in this range, the glass 10 can have a high refractive index while maintaining a high Young's modulus.

### (Content of Fe, Cr, and Ni)

In the glass 10, a total content of Fe, Cr, and Ni is less than 4 ppm, preferably 3 ppm or less, more preferably 2 ppm or less, and further preferably 1 ppm or less, with respect to the entire glass 10 in mass ratio. Fe, Cr, and Ni do not refer to only elemental metals of Fe, Cr, and Ni contained in the glass 10, and may include elemental metals and a compound of Fe, Cr, and Ni. That is, it can be said that the total content of Fe, Cr, and Ni includes the content of elemental metals of Fe, Cr, and Ni and the content of ions of Fe, Cr, and Ni in the compound. When the total content of Fe, Cr, and Ni as coloring transition metals is in this range, a transmittance of the glass 10 with respect to visible light can be prevented from being lowered, and the glass 10 can have a high transmittance with respect to visible light. The total content of Fe, Cr, and Ni can be measured by ICP mass spectrometry. As a measuring instrument, for example, Agilent 8800 manufactured by Agilent Technologies can be used.

In the glass 10, a total content of Fe, Cr, Ni, Cu, Mn, Co, and V is preferably less than 4 ppm, more preferably 3 ppm or less, further preferably 2 ppm or less, and further preferably 1 ppm or less, with respect to the entire glass 10 in mass ratio. Similarly to Fe, Cr, and Ni described above, Fe, Cr, Ni, Cu, Mn, Co, and V described here do not refer to only elemental metals of Fe, Cr, Ni, Cu, Mn, Co, and V contained in the glass 10, and may include elemental metals and a compound of Fe, Cr, Ni, Cu, Mn, Co, and V. That is, it can be said that the total content of Fe, Cr, Ni, Cu, Mn, Co, and V includes the content of elemental metals of Fe, Cr, Ni, Cu, Mn, Co, and V and the content of ions of Fe, Cr, Ni, Cu, Mn, Co, and V in the compound. When the total content of the components described above as coloring transition metals is in this range, a transmittance of the glass 10 with respect to visible light can be prevented from being lowered, and the glass 10 can have a high transmittance with respect to visible light. The total content of the components can be measured by ICP mass spectrometry.

### (Content of Pb)

In the glass 10, a total content of Pb is preferably less than 1000 ppm, more preferably 100 ppm or less, and further preferably 10 ppm or less, with respect to the entire glass 10 in mass ratio. That is, it is preferable that the glass 10 does not substantially contain Pb. Similarly to Fe, Cr, and Ni described above, Pb does not refer to only an elemental metal of Pb contained in the glass 10, and may include an elemental metal and a compound of Pb. That is, it can be said that the content of Pb includes the content of an elemental metal of Pb and the content of ions of Pb in the compound. The content of Pb can be measured by ICP mass spectrometry.

### (Characteristics of Glass)

Characteristics of the glass 10 will be described.

### (Young's Modulus)

In the glass 10, the Young's modulus is preferably 60 GPa or more and less than 100 GPa, more preferably 62 GPa or more and 95 GPa or less, and further preferably 65 GPa or more and 90 GPa or less. Such a high Young's modulus is can appropriately suppress breakage of the glass 10. The Young's modulus can be measured based on propagation of an ultrasonic wave using 38DL PLUS manufactured by Olympus Corporation.

### (Refractive Index n_{d})

In the glass 10, a refractive index n_{d} is preferably 2.00 or more, more preferably 2.04 or more, and further preferably 2.08 or more. When the refractive index n_{d} is in this range, a high refractive index with respect to visible light can be realized. In the glass 10, the refractive index n_{d} is preferably 2.20 or less, more preferably 2.17 or less, and further preferably 2.14 or less.

That is, it can be said that in the glass 10, the refractive index n_{d} is preferably 2.00 or more and 2.20 or less, more preferably 2.04 or more and 2.17 or less, and further preferably 2.08 or more and 2.14 or less.

The refractive index n_{d} refers to a refractive index at the d-line of helium (wavelength: 587.6 nm). The refractive index n_{d} can be measured by a V block method.

### (Wavelength λ₇₀)

A wavelength indicating an internal transmittance of 70% with a plate thickness (thickness) of 10 mm is defined as a wavelength λ₇₀. That is, the wavelength λ₇₀ refers to a wavelength of light at which the internal transmittance is 70% with respect to a sample having a thickness of 10 mm. The wavelength λ₇₀ of the glass 10 with a plate thickness (thickness) of 10 mm is preferably 455 nm or less, more preferably 450 nm or less, and further preferably 445 nm or less. The wavelength λ₇₀ of the glass 10 is preferably 390 nm or more, more preferably 395 nm or more, and further preferably 400 nm or more.

That is, it can be said that the wavelength λ₇₀ of the glass 10 is preferably 390 nm or more and 455 nm or less, more preferably 395 nm or more and 450 nm or less, and further preferably 400 nm or more and 445 nm or less.

When the wavelength λ₇₀ is in this range, a high transmittance with respect to visible light can be realized. The internal transmittance for calculating the wavelength λ₇₀ can be determined from measurement values of two types of external transmittance with different plate thicknesses and the following Formula (1). The external transmittance means a transmittance including a surface reflection loss. In Formula (1), X is the internal transmittance of the glass having a thickness of 10 mm, T1 and T2 are external transmittance, and Δd is a difference between thicknesses of samples. The external transmittance can be measured by using a spectrophotometer (U-4100 manufactured by Hitachi High-Tech Corporation) for a sample both surfaces of which are mirror-polished to have a plate thickness of 10 mm.

$$log X = - \frac{log T 1 - log T 2}{Δ d} \times 10 \qquad ( 1 )$$

### (Transmittance of Light)

In the glass 10, an internal transmittance of light at a wavelength of 440 nm with a plate thickness (thickness) of 10 mm is preferably 80% or more, preferably 87% or more, and further preferably 90% or more.

When the internal transmittance of light at a wavelength of 440 nm is in this range, a high transmittance with respect to visible light can be realized. The internal transmittance of the glass having a thickness of 10 mm can be determined from measurement values of two types of external transmittance with different plate thicknesses and Formula (1).

### (Form of Glass)

The glass 10 according to the present embodiment is preferably an optical glass, and is preferably a glass plate having a thickness of 0.01 mm or more and 2.0 mm or less. When the thickness is 0.01 mm or more, the glass 10 can be prevented from being damaged at the time of handling or processing. The deflection of the glass 10 caused by its own weight can be suppressed. The thickness is more preferably 0.1 mm or more, further preferably 0.2 mm or more, and still more preferably 0.3 mm or more. On the other hand, when the thickness is 2.0 mm or less, a weight of an optical element using the glass 10 can be reduced. The thickness is more preferably 1.5 mm or less, further preferably 1.0 mm or less, and still more preferably 0.8 mm or less.

When the glass 10 according to the present embodiment is a glass plate, an area of a principal surface is preferably 8 cm² or more. When the area is 8 cm² or more, a large number of optical elements can be disposed to improve productivity. The area is more preferably 30 cm² or more, further preferably 170 cm² or more, still more preferably 300 cm² or more, and particularly preferably 1000 cm² or more. On the other hand, when the area is 6500 cm² or less, handling of the glass plate becomes easy, and the glass plate can be prevented from being damaged at the time of handling or processing. The area is more preferably 4500 cm² or less, further preferably 4000 cm² or less, still more preferably 3000 cm² or less, and particularly preferably 2000 cm² or less.

When the glass 10 according to the present embodiment is a glass plate, a local thickness variation (LTV) in 25 cm² of a principal surface is preferably 2 μm or less. Flatness in this range enables to form a nanostructure with a desired shape on a principal surface by using an imprinting technique or the like, and to obtain desired light guide characteristics. In particular, a ghost phenomenon and distortion due to a difference in optical lengths can be prevented in a light guide. The LTV is more preferably 1.5 μm or less, further preferably 1.0 μm or less, and particularly preferably 0.5 μm or less.

When the glass 10 according to the present embodiment is a circular glass plate with a diameter of 8 inches, warpage thereof is preferably 50 μm or less. When the warpage of the glass 10 is 50 μm or less, a nanostructure with a desired shape can be formed on a principal surface by using an imprinting technique or the like, and desired light guide characteristics are obtained. When a plurality of light guides are to be obtained, stable quality is obtained. The warpage of the glass 10 is more preferably 40 μm or less, further preferably 30 μm or less, and particularly preferably 20 μm or less.

When the glass 10 according to the present embodiment is a circular glass plate with a diameter of 6 inches, warpage thereof is preferably 30 μm or less. When the warpage of the glass 10 is 30 μm or less, a nanostructure with a desired shape can be formed on a principal surface by using an imprinting technique or the like, and desired light guide characteristics are obtained. When a plurality of light guides are to be obtained, stable quality is obtained. The warpage of the glass 10 is more preferably 20 μm or less, further preferably 15 μm or less, and particularly preferably 10 μm or less.

When the glass 10 according to the present embodiment is a square glass plate having each side of 6 inches, warpage thereof is preferably 100 μm or less. When the warpage of the glass 10 is 100 μm or less, a nanostructure with a desired shape can be formed on a principal surface by using an imprinting technique or the like, and desired light guide characteristics are obtained. When a plurality of light guides are to be obtained, stable quality is obtained. The warpage of the glass 10 is more preferably 70 μm or less, further preferably 50 μm or less, further preferably 35 μm or less, and particularly preferably 20 μm or less.

FIG. 2 is a cross-sectional view assuming that the glass according to the present embodiment is a glass plate. When the glass 10 according to the present embodiment is a glass plate G1, “warpage” is a difference C between a maximum value B and a minimum value A of a distance between a reference line G1D of the glass plate G1 and a center line G1C of the glass plate G1 in a vertical direction at an arbitrary cross-section which passes a center of a principal surface G1F of the glass plate G1 and is orthogonal to the principal surface G1F of the glass plate G1.

An intersection line between the orthogonal arbitrary cross-section and the principal surface G1F of the glass plate G1 is defined as a base line G1A. An intersection line between the orthogonal arbitrary cross-section and other principal surface G1G of the glass plate G1 is defined as an upper line G1B. The center line G1C is a line connecting each center in a plate thickness direction of the glass plate G1. The center line G1C is calculated by determining a midpoint between the base line G1A and the upper line G1B with respect to a laser irradiation direction described below.

The reference line G1D is determined as follows. First, the base line G1A is calculated based on a measuring method in which effect due to its own weight is canceled. A straight line is determined by a least squares method from the base line G1A. The determined straight line is the reference line G1D. As the measuring method in which effect due to its own weight is canceled, a known method is used.

For example, the principal surface G1F of the glass plate G1 is three-point supported, then laser is irradiated on the glass plate G1 by a laser displacement gauge, and heights of the principal surface G1F and the other principal surface G1G of the glass plate G1 are measured from an arbitrary reference plane.

Next, the glass plate G1 is reversed, then three points of the other principal surface G1G opposing to the three points which have supported one principal surface G1F are supported, and heights of the principal surface G1F and the other principal surface G1G of the glass plate G1 are measured from the arbitrary reference plane.

The effect due to its own weight is canceled by determining averages of heights at respective measurement points before and after the reverse. For example, the height of the principal surface G1F is measured before the reverse as described above. After the glass plate G1 is reversed, the height of the other principal surface G1G is measured at a position corresponding to the measurement point of the principal surface G1F. Similarly, the height of the other principal surface G1G is measured before the reverse. After the glass plate G1 is reversed, the height of the principal surface G1F is measured at a position corresponding to the measurement point of the other principal surface G1G.

Warpage is measured by, for example, the laser displacement gauge.

In the glass 10 according to the present embodiment, surface roughness Ra of the principal surface is preferably 2 nm or less. The Ra in this range enables to form a nanostructure with a desired shape on a principal surface by using an imprinting technique or the like, and to obtain desired light guide characteristics. In particular, irregular reflection at an interface is suppressed in the light guide, and a ghost phenomenon and distortion can be prevented. The Ra is more preferably 1.7 nm or less, further preferably 1.4 nm or less, still more preferably 1.2 nm or less, and particularly preferably 1 nm or less. The surface roughness Ra is arithmetic mean roughness defined in JIS B0601 (2001). In the present specification, the surface roughness Ra is a value obtained by measuring an area of 10 μm×10 μm by using an atomic force microscope (AFM).

### (Method for Producing Glass)

A method for producing the glass 10 according to the present embodiment is not particularly limited, and a known method for producing a plate glass can be used. For example, a known method such as a float method, a fusion method, or a roll-out method can be used. However, in order to suppress deterioration of the transmittance of the glass 10 caused by mixing of impurities, Au and an Au alloy are preferably used as a material of a vessel (crucible) in which raw materials are put at the time of melting the raw materials.

For the glass 10 of the present embodiment, it is preferable to perform an operation of increasing an amount of moisture in molten glass in a melting process of heating and melting glass raw materials in a melting vessel to obtain the molten glass. The operation of increasing the amount of moisture in the glass is not limited, and for example, the operation may be processing of adding water vapor to melting atmosphere, and processing of bubbling gas containing water vapor into a molten material. The operation of increasing the amount of moisture is not essential, but can be performed for the purpose of improving transmittance, improving clarity, and the like.

The glass 10 of the present embodiment containing an alkali metal oxide such as Li₂O or Na₂O can be chemically strengthened by substituting a Na ion or a K ion for a Li ion, and substituting a K ion for a Na ion. That is, the strength of the optical glass can be improved by chemical strengthening processing.

### (Effects)

As described above, in glass 10 according to the present embodiment, in mole percentage on an oxide basis, the content of TeO₂ is more than 10.1% and less than 40.0%, the parameter A defined by Formula (A) above is 65 or more, and the total content of P₂O₅, TeO₂, B₂O₃, TiO₂, Ta₂O₅, WO₃, ZrO₂, Bi₂O₃, and ZnO is 90% or more. Glass having a high refractive index may be brittle and thus easily broken. On the other hand, when the content of TeO₂ and the total content of the respective components are in the above ranges and the parameter A is 65 or more, the glass 10 according to the present embodiment can have a high refractive index (for example, the refractive index n_{d} is 2.00 or more) and a high Young's modulus (for example, 65 GPa or more), and breakage can be suppressed while achieving a high refractive index.

In the glass 10 according to the present embodiment, it is preferable that the content of TeO₂ is 15% or more and 36.5% or less and the content of Bi₂O₃ is 18% or more and 42% or less. When the contents of these components are in the above ranges, the glass 10 according to the present embodiment can achieve a high refractive index and a high Young's modulus and also a high transmittance with visible light.

The glass 10 according to the present embodiment preferably contains, in mole percentage on an oxide basis:
P₂O₅: 0% or more and 30% or less;
TeO₂: 10.1% or more and less than 40%;
B₂O₃: 0% or more and 40% or less;
Li₂O: 0% or more and 15% or less;
Na₂O: 0% or more and 15% or less;
K₂O: 0% or more and 15% or less;
TiO₂: 0% or more and 20% or less;
Ta₂O₅: 0% or more and 20% or less;
WO₃: 0% or more and 15% or less;
Nb₂O₅: 0% or more and less than 15%;
ZrO₂: 0% or more and 15% or less;
Bi₂O₃: more than 15% and 45% or less; and
ZnO: 0% or more and 20% or less. When the contents of these components are in the above ranges, the glass 10 according to the present embodiment can achieve a high refractive index and a high Young's modulus and also a high transmittance with visible light.

In the glass 10 according to the present embodiment, a total content of Fe, Cr, and Ni is preferably smaller than 4 ppm by mass. Accordingly, a high refractive index, a high transmittance, and a high Young's modulus can be more suitably realized.

In the glass 10 according to the present embodiment, it is preferable that a Young's modulus is 60 GPa or more, a refractive index is 2.00 or more, and an internal transmittance of light at a wavelength of 440 nm with a plate thickness of 10 mm is 80% or more. As a result, breakage can be appropriately suppressed while achieving a high refractive index and a high transmittance.

In the glass 10 according to the present embodiment, it is preferable that a thickness is 0.01 mm or more and 2.0 mm or less, and a surface area is 8 cm² or more. According to the present embodiment, it is possible to suppress breakage of the glass 10 having such a shape while achieving a high refractive index.

The glass 10 according to the present embodiment is preferably used as a light guide plate. Since the glass 10 has a high refractive index and a high Young's modulus, the glass 10 is appropriately used as a light guide plate.

### Examples

Next, Examples will be described. The embodiment may be modified as long as the effect of the invention is exhibited.

In Examples, pieces of glass respectively having different compositions were produced. The refractive index, the transmittance, and the glass transition temperature Tg of each glass were evaluated. Hereinafter, description will be given in more detail.

Table 1 is a table showing materials used for glass in Examples. Table 1 shows, for examples 1 to 37, the content of the material used for producing glass in mole percentage on an oxide basis. The total content of nine components of P₂O₅, TeO₂, B₂O₃, TiO₂, Ta₂O₅, WO₃, ZrO₂, Bi₂O₃, and ZnO and the content ratio (molar ratio) of TeO₂ to B₂O₃ in mole percentage on an oxide basis are shown in Table 1. The calculated values of the parameter A described in the above-described examples for the pieces of glass in the respective examples are also shown in Table 1. Note that examples 1 to 36 represent Examples, and example 37 represents Comparative Example.

TABLE 1

| | Composition (mol %) | | | | | | | | | | | | | |
|---|---|---|---|---|---|---|---|---|---|---|---|---|---|---|
| | P₂O₅ | TeO₂ | B₂O₃ | Li₂O | Na₂O | K₂O | TiO₂ | Ta₂O₅ | WO₃ | Nb₂O₅ | ZrO₂ | Bi₂O₃ | ZnO | Total |
| Example 1 | 9.7 | 25.6 | 21.6 | 0.0 | 0.0 | 0.0 | 0.0 | 0.5 | 0.0 | 6.7 | 0.0 | 30.5 | 5.4 | 100.0 |
| Example 2 | 9.7 | 25.6 | 22.1 | 0.0 | 0.0 | 0.0 | 0.0 | 0.0 | 0.0 | 6.7 | 0.0 | 30.5 | 5.4 | 100.0 |
| Example 3 | 9.6 | 25.5 | 21.5 | 0.0 | 0.0 | 0.0 | 0.0 | 0.0 | 0.0 | 6.7 | 0.0 | 30.4 | 6.4 | 100.0 |
| Example 4 | 9.7 | 25.6 | 21.6 | 0.0 | 0.0 | 0.0 | 0.0 | 0.0 | 0.0 | 6.7 | 0.0 | 31.0 | 5.4 | 100.0 |
| Example 5 | 10.2 | 25.6 | 21.6 | 0.0 | 0.0 | 0.0 | 0.0 | 0.0 | 0.0 | 6.7 | 0.0 | 30.5 | 5.4 | 100.0 |
| Example 6 | 9.6 | 25.5 | 21.5 | 0.0 | 0.0 | 0.0 | 1.0 | 0.0 | 0.0 | 6.7 | 0.0 | 30.4 | 5.4 | 100.0 |
| Example 7 | 9.6 | 24.5 | 21.5 | 0.0 | 0.0 | 0.0 | 2.0 | 0.0 | 0.0 | 6.7 | 0.0 | 30.4 | 5.4 | 100.0 |
| Example 8 | 9.7 | 24.7 | 22.2 | 0.0 | 0.0 | 0.0 | 0.0 | 0.5 | 0.0 | 6.7 | 0.0 | 30.7 | 5.4 | 100.0 |
| Example 9 | 9.7 | 24.6 | 21.6 | 0.0 | 0.0 | 0.0 | 1.0 | 0.5 | 0.0 | 6.7 | 0.0 | 30.5 | 5.4 | 100.0 |
| Example 10 | 9.6 | 22.5 | 21.5 | 0.0 | 0.0 | 0.0 | 4.0 | 0.0 | 0.0 | 6.7 | 0.0 | 30.4 | 5.4 | 100.0 |
| Example 11 | 9.7 | 24.7 | 21.7 | 0.0 | 0.0 | 0.0 | 0.0 | 1.0 | 0.0 | 6.7 | 0.0 | 30.7 | 5.4 | 100.0 |
| Example 12 | 9.7 | 24.7 | 21.7 | 0.0 | 0.0 | 0.0 | 0.0 | 0.0 | 1.0 | 6.7 | 0.0 | 30.7 | 5.4 | 100.0 |
| Example 13 | 9.8 | 22.9 | 21.9 | 0.0 | 0.0 | 0.0 | 0.0 | 0.0 | 0.0 | 6.8 | 0.0 | 33.0 | 5.5 | 100.0 |
| Example 14 | 9.8 | 20.9 | 21.9 | 0.0 | 0.0 | 0.0 | 2.0 | 0.0 | 0.0 | 6.8 | 0.0 | 33.0 | 5.5 | 100.0 |
| Example 15 | 9.6 | 18.5 | 21.5 | 0.0 | 0.0 | 0.0 | 8.0 | 0.0 | 0.0 | 6.7 | 0.0 | 30.4 | 5.4 | 100.0 |
| Example 16 | 9.6 | 24.5 | 21.5 | 0.0 | 0.0 | 0.0 | 0.0 | 0.0 | 0.0 | 6.7 | 2.0 | 30.4 | 5.4 | 100.0 |
| Example 17 | 9.6 | 22.5 | 21.5 | 0.0 | 0.0 | 0.0 | 2.0 | 0.0 | 0.0 | 6.7 | 2.0 | 30.4 | 5.4 | 100.0 |
| Example 18 | 9.8 | 23.8 | 21.8 | 0.5 | 0.5 | 0.5 | 0.0 | 0.0 | 0.0 | 6.8 | 0.0 | 30.9 | 5.4 | 100.0 |
| Example 19 | 9.7 | 25.6 | 21.6 | 0.0 | 0.0 | 0.0 | 0.0 | 0.0 | 0.0 | 7.2 | 0.0 | 30.5 | 5.4 | 100.0 |
| Example 20 | 8.6 | 34.5 | 19.5 | 0.0 | 0.0 | 0.0 | 0.0 | 0.0 | 0.0 | 4.7 | 0.0 | 27.4 | 5.4 | 100.0 |
| Example 21 | 9.6 | 36.1 | 16.5 | 0.0 | 0.0 | 0.0 | 0.0 | 0.0 | 0.0 | 5.2 | 0.0 | 29.3 | 3.4 | 100.0 |
| Example 22 | 15.1 | 26.5 | 18.2 | 0.0 | 0.0 | 0.0 | 0.0 | 0.0 | 0.0 | 6.0 | 0.5 | 29.7 | 4.1 | 100.0 |
| Example 23 | 13.7 | 26.5 | 18.2 | 0.0 | 0.0 | 0.0 | 0.0 | 1.5 | 0.4 | 6.0 | 0.0 | 29.6 | 4.2 | 100.0 |
| Example 24 | 9.6 | 26.7 | 21.0 | 2.0 | 0.0 | 0.0 | 0.0 | 0.0 | 0.0 | 6.5 | 0.0 | 29.5 | 4.8 | 100.0 |
| Example 25 | 9.6 | 25.9 | 21.5 | 0.0 | 1.0 | 1.0 | 0.0 | 0.0 | 0.0 | 6.1 | 0.0 | 30.4 | 4.6 | 100.0 |
| Example 26 | 9.4 | 26.1 | 22.2 | 0.0 | 0.0 | 0.0 | 10.5 | 0.0 | 0.0 | 3.2 | 0.0 | 23.9 | 4.8 | 100.0 |
| Example 27 | 9.4 | 26.4 | 21.5 | 0.0 | 0.0 | 0.0 | 0.0 | 0.0 | 0.0 | 6.4 | 4.0 | 27.1 | 5.3 | 100.0 |
| Example 28 | 9.3 | 26.5 | 21.2 | 0.0 | 0.0 | 0.0 | 0.0 | 0.0 | 0.0 | 2.7 | 8.0 | 27.0 | 5.4 | 100.0 |
| Example 29 | 10.1 | 26.3 | 20.8 | 0.0 | 0.0 | 0.0 | 0.0 | 3.0 | 0.0 | 6.2 | 0.0 | 28.7 | 5.0 | 100.0 |
| Example 30 | 9.5 | 20.4 | 21.0 | 0.0 | 0.0 | 0.0 | 0.0 | 0.0 | 0.0 | 5.7 | 10.1 | 28.3 | 5.1 | 100.0 |
| Example 31 | 9.6 | 26.5 | 21.5 | 0.0 | 0.0 | 0.0 | 0.0 | 0.0 | 0.0 | 6.7 | 0.0 | 30.4 | 5.4 | 100.0 |
| Example 32 | 7.4 | 15.7 | 31.1 | 0.0 | 0.0 | 0.0 | 0.0 | 0.0 | 0.0 | 7.9 | 1.0 | 32.1 | 4.9 | 100.0 |
| Example 33 | 6.4 | 16.7 | 28.3 | 0.0 | 0.0 | 0.0 | 0.0 | 0.0 | 0.0 | 7.7 | 0.0 | 36.1 | 4.9 | 100.0 |
| Example 34 | 6.2 | 16.4 | 29.1 | 0.0 | 0.0 | 0.0 | 0.0 | 0.0 | 0.0 | 5.8 | 0.0 | 38.1 | 4.5 | 100.0 |
| Example 35 | 8.6 | 29.5 | 22.2 | 0.9 | 0.0 | 0.0 | 0.0 | 0.0 | 0.0 | 9.0 | 0.0 | 21.3 | 8.5 | 100.0 |
| Example 36 | 5.6 | 18.8 | 26.3 | 3.0 | 0.0 | 0.0 | 2.3 | 0.5 | 0.0 | 1.6 | 0.0 | 32.5 | 9.5 | 100.0 |
| Example 37 | 7.1 | 26.3 | 21.6 | 5.6 | 0.0 | 0.0 | 0.0 | 0.0 | 0.0 | 5.6 | 0.0 | 28.3 | 5.6 | 100.0 |

| | | TeO₂/ | | Evaluation | | | |
|---|---|---|---|---|---|---|---|
| | Total content | B₂O₃ | | Young's | Refractive | Internal | |
| | (mol %) of nine | (molar | Parameter | modulus | index | transmittance (%) | |
| | components | ratio) | A | (GPa) | nd | @440 nm | λ₇₀ |
| Example 1 | 93.3 | 1.2 | 70.7 | 70.0 | 2.1024 | 92.4 | 416 |
| Example 2 | 93.3 | 1.2 | 70.5 | 70.5 | 2.0988 | 92.9 | 415 |
| Example 3 | 93.3 | 1.2 | 70.0 | 70.0 | 2.0939 | 92.7 | 416 |
| Example 4 | 93.3 | 1.2 | 70.2 | 69.9 | 2.1025 | 91.8 | 416 |
| Example 5 | 93.3 | 1.2 | 71.6 | 71.6 | 2.0964 | 93.2 | 415 |
| Example 6 | 93.3 | 1.2 | 70.8 | 71.4 | 2.1033 | 91.6 | 419 |
| Example 7 | 93.3 | 1.1 | 71.7 | 72.1 | 2.1062 | 90.0 | 422 |
| Example 8 | 93.3 | 1.1 | 71.2 | 71.3 | 2.0993 | 93.2 | 415 |
| Example 9 | 93.3 | 1.1 | 71.5 | 71.5 | 2.1037 | 91.2 | 420 |
| Example 10 | 93.3 | 1.0 | 73.3 | 73.1 | 2.1118 | 86.8 | 427 |
| Example 11 | 93.3 | 1.1 | 71.4 | 71.7 | 2.1027 | 92.5 | 416 |
| Example 12 | 93.3 | 1.1 | 70.9 | 70.9 | 2.1042 | 89.6 | 424 |
| Example 13 | 93.2 | 1.0 | 70.7 | 70.7 | 2.1123 | 91.9 | 418 |
| Example 14 | 93.2 | 1.0 | 72.4 | 72.4 | 2.1178 | 89.2 | 424 |
| Example 15 | 93.3 | 0.9 | 76.7 | 76.6 | 2.1229 | 81.9 | 432 |
| Example 16 | 93.3 | 1.1 | 71.7 | 71.6 | 2.1000 | 92.7 | 416 |
| Example 17 | 93.3 | 1.0 | 73.4 | 73.5 | 2.1054 | 90.1 | 422 |
| Example 18 | 91.7 | 1.1 | 70.1 | 69.8 | 2.0930 | 89.9 | 424 |
| Example 19 | 92.8 | 1.2 | 70.0 | 69.9 | 2.1025 | 89.7 | 423 |
| Example 20 | 95.3 | 1.8 | 66.5 | 66.8 | 2.0946 | 93.8 | 415 |
| Example 21 | 94.8 | 2.2 | 66.9 | 67.1 | 2.1135 | 92.5 | 417 |
| Example 22 | 94.0 | 1.5 | 83.7 | 83.8 | 2.0640 | 92.1 | 418 |
| Example 23 | 94.0 | 1.5 | 81.0 | 81.2 | 2.0790 | 93.3 | 415 |
| Example 24 | 91.5 | 1.3 | 69.1 | 68.0 | 2.0559 | 88.7 | 424 |
| Example 25 | 91.9 | 1.2 | 69.5 | 69.6 | 2.1047 | 92.5 | 416 |
| Example 26 | 96.8 | 1.2 | 80.0 | 80.6 | 2.0795 | 84.9 | 430 |
| Example 27 | 93.6 | 1.2 | 73.1 | 73.1 | 2.0826 | 93.1 | 415 |
| Example 28 | 97.3 | 1.2 | 77.2 | 77.9 | 2.0691 | 93.5 | 413 |
| Example 29 | 93.8 | 1.3 | 74.1 | 74.2 | 2.0950 | 93.1 | 414 |
| Example 30 | 94.3 | 1.0 | 78.5 | 78.6 | 2.0863 | 93.7 | 413 |
| Example 31 | 93.3 | 1.2 | 70.0 | 70.0 | 2.1006 | 90.1 | 422 |
| Example 32 | 92.1 | 0.5 | 71.0 | 70.9 | 2.0890 | 89.5 | 424 |
| Example 33 | 92.3 | 0.6 | 65.3 | 65.2 | 2.1138 | 85.2 | 428 |
| Example 34 | 94.2 | 0.6 | 65.8 | 66.0 | 2.1201 | 82.9 | 431 |
| Example 35 | 90.1 | 1.3 | 67.2 | 66.2 | 2.0448 | 91.2 | 421 |
| Example 36 | 95.4 | 0.7 | 65.3 | 64.5 | 2.0453 | 84.1 | 430 |
| Example 37 | 88.8 | 1.2 | 61.7 | 58.9 | 1.9882 | 85.3 | 429 |

In Examples, pieces of glass respectively having thicknesses of 10 mm and 1 mm were produced with compositions described in the respective examples in Table 1. The pieces of glass produced as described above were used as samples to perform evaluation. Specifically, raw materials with compositions shown in Table 1 were uniformly mixed, and molten for 2 hours in a gold crucible at 950° C. to be uniform molten glass. Next, the molten glass was poured into a mold made of carbon having a size of length×width×height=length 60 mm×width 50 mm×height 30 mm. Thereafter, the molten glass was held for 1 hour at 430° C. and cooled to room temperature at a temperature decreasing rate of about 1° C./min to obtain a glass block. Next, the glass block was cut to have a size of length×width=30 mm×30 mm using a cutting machine (compact cutting machine manufactured by MARUTO INSTRUMENT CO., LTD.), and adjustment of a plate thickness and surface polishing were performed thereon using a grinding machine (SGM-6301 manufactured by Shuwa Industry co., ltd.) and a single-side polishing machine (EJ-380IN manufactured by Engis Japan Corporation) to produce glass plates each having a size of length×width=30 mm×30 mm and having a plate thicknesses of 10 mm and 1 mm.

### (Evaluation)

For the pieces of glass in the respective examples, the Young's modulus and the refractive index with respect to visible light were evaluated.

In evaluation of the Young's modulus, the Young's modulus was measured for each piece of the glass based on propagation of an ultrasonic wave using 38DL PLUS manufactured by Olympus Corporation. In evaluation of the Young's modulus, the Young's modulus of 60 GPa or more was accepted, and the Young's modulus of less than 60 GPa was rejected.

In evaluation of the refractive index, the refractive index n_{d} at the d-line of helium (wavelength: 587.6 nm) was measured for each piece of the glass. For the measurement of the refractive index n_{d}, KPR-2000 manufactured by Kalnew was used. In evaluation of the refractive index, the refractive index n_{d} of 2.00 or more was accepted, and the refractive index n_{d} of less than 2.00 was rejected.

A case where the Young's modulus is 60 GPa or more and the refractive index n_{d} is 2.00 or more was accepted. A case not satisfying at least one of a Young's modulus of 60 GPa or more and a refractive index n_{d} of 2.00 or more was rejected.

As optional evaluation, the transmittance was evaluated. In evaluation of the transmittance, the internal transmittance of light at a wavelength of 440 nm and the wavelength λ₇₀ indicating an internal transmittance of 70% with a plate thickness of 10 mm were measured for each piece of the glass. The internal transmittance of light at a wavelength of 440 nm was calculated from measurement values of two types of external transmittance with different plate thicknesses measured using U-4100 manufactured by Hitachi High-Tech Corporation and Formula (1). For the measurement of the wavelength λ₇₀, U-4100 manufactured by Hitachi High-Tech Corporation was used.

### (Evaluation Results)

As shown in Table 1, it is found that, in examples 1 to 36 as Examples, the Young's modulus and the refractive index n_{d} are accepted, the refractive index is high, and the breakage can be suppressed. In example 37 as Comparative Example in which the total content of nine components is not 90% or more and the parameter A is not 65 or more, it is found that at least one of the Young's modulus and the refractive index n_{d} is rejected, the refractive index is high, and it is not possible to realize that breakage can be suppressed.

Although the embodiment of the present invention has been described, the embodiment is not limited by the contents of the embodiment. The constituent elements described above include a constituent element that is easily conceivable by those skilled in the art, substantially the same constituent element, and what is called an equivalent. The constituent elements described above can be appropriately combined. The constituent elements can be variously omitted, replaced, or modified without departing from the gist of the embodiment described above.

### REFERENCE SIGNS LIST

10 GLASS

1. Glass in which, in mole percentage on an oxide basis, a content of TeO₂ is more than 10.1% and less than 40.0%, a parameter A defined by Formula (A) is 65 or more, and a total content of P₂O₅, TeO₂, B₂O₃, TiO₂, Ta₂O₅, WO₃, ZrO₂, Bi₂O₃, and ZnO is 90% or more,
$$A = 3.11462 0 \cdot c ( {P}_{2} {O}_{5} ) + 0.30878 \cdot c ( {TeO}_{2} ) + 1.018169 \cdot c ( {B}_{2} {O}_{3} ) + 1.144722 \cdot c ( {TiO}_{2} ) + 1.296491 \cdot c ( {Ta}_{2} {O}_{5} ) + 0.815743 \cdot c ( {WO}_{3} ) + 1.172518 \cdot c ( {ZrO}_{2} ) + 0.266476 \cdot c ( {Bi}_{2} {O}_{3} ) + 0.339981 \cdot c ( ZnO ) \qquad ( A )$$
where
c(P₂O₅) is a content (%) of P₂O₅ in mole percentage on an oxide basis,
c(TeO₂) is a content (%) of TeO₂ in mole percentage on an oxide basis,
c(B₂O₃) is a content (%) of B₂O₃ in mole percentage on an oxide basis,
c(TiO₂) is a content (%) of TiO₂ in mole percentage on an oxide basis,
c(Ta₂O₅) is a content (%) of Ta₂O₅ in mole percentage on an oxide basis,
c(WO₃) is a content (%) of WO₃ in mole percentage on an oxide basis,
c(ZrO₂) is a content (%) of ZrO₂ in mole percentage on an oxide basis,
c(Bi₂O₃) is a content (%) of Bi₂O₃ in mole percentage on an oxide basis, and
c(ZnO) is a content (%) of ZnO in mole percentage on an oxide basis.

2. The glass according to claim 1, wherein in mole percentage on an oxide basis, a content of TeO₂ is 15% or more and 36.5% or less, and a content of Bi₂O₃ is 18% or more and 42% or less.

3. The glass according to claim 2, comprising, in mole percentage on an oxide basis:
P₂O₅: 0% or more and 30% or less;
TeO₂: 10.1% or more and less than 40%;
B₂O₃: 0% or more and 40% or less;
Li₂O: 0% or more and 15% or less;
Na₂O: 0% or more and 15% or less;
K₂O: 0% or more and 15% or less;
TiO₂: 0% or more and 20% or less;
Ta₂O₅: 0% or more and 20% or less;
WO₃: 0% or more and 15% or less;
Nb₂O₅: 0% or more and less than 15%;
ZrO₂: 0% or more and 15% or less;
Bi₂O₃: more than 15% and 45% or less; and
ZnO: 0% or more and 20% or less.

4. The glass according to claim 1, wherein a total content of Fe, Cr, and Ni is smaller than 4 ppm by mass.

5. The glass according to claim 1, wherein a Young's modulus is 60 GPa or more, a refractive index is 2.00 or more, and an internal transmittance of light at a wavelength of 440 nm with a plate thickness of 10 mm is 80% or more.

6. The glass according to claim 1, wherein a thickness is 0.01 mm or more and 2.0 mm or less, and a surface area is 8 cm² or more.

7. The glass according to claim 1, which is used as a light guide plate.
